(19) United States
(12) Patent Application Publication
(10) Pub. No.: US 2017/0167172 A1
(43) Pub. Date: Jun. 15, 2017

(54) REMOVABLY INTERLOCKING BARREL HINGE

(71) Applicant: Liquidmetal Technologies, Inc., Rancho Santa Margarita, CA (US)

(72) Inventors: Glenton R. Jelbert, Foothill Ranch, CA (US); Sean T. O'Keeffe, Tustin, CA (US); Adam A. Verreault, Foothill Ranch, CA (US)

(21) Appl. No.: 14/966,825

(22) Filed: Dec. 11, 2015

(51) Int. Cl. E05D 7/10; B26B 1/04

(52) U.S. Cl. CPC E05D 7/105; B26B 1/04; E05Y 2900/60

(57) ABSTRACT

Disclosed is a removably interlocking barrel hinge assembly that allows for relative rotation of parts as well as disconnection of the parts. Connectors of the hinge assembly include tabs and recesses that are configured to align and rotate relative to one another. Overlapping of tabs prevents separation in the axial direction, while still allowing for rotation. When disconnection of the parts is desired, the tabs and recesses of the connectors can be aligned, and then pulled apart. The hinge assembly provides in one instance 180 degrees of relative rotation. It may be implemented in a number of devices, including knives and surgical instruments, for example.

### BACKGROUND

Field

The present invention is generally related to a hinge, and, more specifically, an interlocking barrel hinge that enables parts to be rotated about a larger range of motion while still allowing disconnection of those parts.

Description of Related Art

Hinges that can be disconnected have been used in a number of devices. For example, some kitchen shears are designed to come apart and disconnect via a joining hinge connection. However, such known hinge designs are limited in their range of motion. Further, the connecting parts are unable to move at least 180 degrees relative to one another. Moreover, the configuration of the attachment is limited in support throughout the relative motion of the connected parts.

Known barrel hinges, which can be used as a disconnecting hinge, typically use a centering pin or tube which is inserted into a barrel part, and fastened with a split ring, clip or other fastening mechanism. This means multiple components, a generally more time consuming assembly, and a more difficult disassembly (for maintenance or cleaning).

Further, forming and manufacturing such components can be difficult, particularly when parts are molded, because each component requires a mold.

### SUMMARY

It is an aspect of this disclosure to provide a removably interlocking barrel hinge assembly. The assembly includes a first connector and a second connector. The first connector has a first body with a first opening therethrough. The first body has an inner wall surrounding the opening and a plurality of tabs spaced circumferentially around the inner wall, each of the tabs projecting from the inner wall into the opening. The second connector has a second body with a second opening therethrough. The second body has an outer wall with a shoulder extending therefrom and a receiving slot. The receiving slot is configured for receipt of and sliding movement in a sliding direction of the plurality of tabs of the first body therein. The shoulder is configured to limit motion of the tabs in an axial direction. The shoulder also includes a corresponding number of recesses of complimentary shape to the plurality of tabs that are spaced circumferentially around the shoulder. The first opening and the second opening of the connectors are axially aligned when connected and assembled. At least one of the first connector and the second connector is configured for rotation about the axis relative to the other connector such that the tabs of the first connector are moved relatively in the sliding direction within the slot of the second connector and are secured at least part by the shoulder, thereby preventing separation of the first and second connectors in the axial direction. Upon alignment of the plurality of tabs of the first connector with the recesses in the shoulder of the second connector, the first connector and second connector are configured for disconnection in the axial direction via movement away from each other along the axis.

Another aspect provides a knife having a blade, a blade protector device, and a removably interlocking barrel hinge assembly connecting the blade and the blade protector device. The removably interlocking barrel hinge assembly of the knife includes a first connector provided on the blade having a first opening therethrough and a second connector provided on the blade protector device having a second body with a second opening therethrough. The blade has an inner wall surrounding the opening and a plurality of tabs spaced circumferentially around the inner wall, each of the tabs projecting from the inner wall into the opening. The blade protector device has an outer wall with a shoulder extending therefrom and a receiving slot. The receiving slot is configured for receipt of and sliding movement in a sliding direction of the plurality of tabs of the blade therein and the shoulder configured to limit motion of the tabs in an axial direction. The shoulder further includes a corresponding number of recesses of complimentary shape to the plurality of tabs, and the corresponding number of recesses is spaced circumferentially around the shoulder. The first opening and the second opening of the connectors are axially aligned. At least one of the first connector and the second connector is configured for rotation about the axis relative to the other connector such that the tabs of the first connector are moved relatively in the sliding direction within the slot of the second connector and are secured at least part by the shoulder, thereby preventing separation of the first and second connectors in the axial direction, and allowing relative rotation of the blade and blade protector device. Upon alignment of the plurality of tabs of the first connector with the recesses in the shoulder of the second connector, the first connector and second connector are configured for disconnection in the axial direction via movement away from each other along the axis, thereby disconnecting the blade from the blade protector device.

Other aspects, features, and advantages of the present invention will become apparent from the following detailed description, the accompanying drawings, and the appended claims.

### BRIEF DESCRIPTION OF THE DRAWINGS

FIG. 1 is a plan view of a first connector of a hinge assembly according to an embodiment of this disclosure.

FIG. 2 is a top view of the first connector of FIG. 1.

FIG. 3 is a plan view of a second connector of the hinge assembly according to an embodiment of this disclosure.

FIG. 4 is a top view of the second connector of FIG. 3.

FIG. 5 is a plan view of the first and second connectors in the hinge assembly in an assembled position in accordance with an embodiment of this disclosure.

FIG. 5A is a schematic diagram showing features related to overlapping tabs.

FIG. 6 is a cross sectional view taken along line 6-6 in FIG. 5, showing details of the connection between the first and second connectors.

FIG. 7 is a top view of the first and second connectors of the hinge assembly in a position for assembly or disassembly, in accordance with an embodiment.

FIGS. 8-11 illustrate relative positions of the first and second connectors during rotation of at least one of the connectors.

FIGS. 12 and 13 illustrate first and second connectors, respectively, of another embodiment of the hinge assembly, having alternately shaped body portions that include brackets.

FIGS. 14 and 15 illustrate first and second connectors, respectively, of another embodiment of the hinge assembly, having alternately shaped body portions that include elongated bodies.

FIGS. 16 and 17 illustrate first and second connectors, respectively, of another embodiment of the hinge assembly, having alternately shaped body portions that include angled brackets.

FIG. 18 illustrates a plan view of disassembled or separated parts of a pocket knife incorporating parts of the disclosed hinge assembly, in accordance with an embodiment.

FIG. 19 illustrates connection or assembly of the parts of the knife in FIG. 18.

FIGS. 20 and 21 illustrate plan views of a first side and a second side of the assembled knife when the connectors of the hinge assembly are connected.

FIGS. 22 and 23 illustrate the movement or rotation of the second part of the knife relative to the first part using the herein disclosed hinge assembly.

FIG. 24 illustrates an exploded view of parts of a folding knife, including a blade and handle, that utilize the parts of the disclosed hinge assembly, in accordance with another embodiment.

FIGS. 25-26 illustrate plan views of a surgical instrument, including a handle and a jaw, that utilize the parts of the disclosed hinge assembly, in accordance with another embodiment.

FIG. 27 is a graph showing support and rotation results related to optimizing the design of the disclosed hinge, in accordance with an embodiment.

FIG. 28 illustrates exemplary embodiments of electronic devices utilizing the disclosed hinge assembly, in accordance with yet another embodiment.

FIGS. 29 and 30 illustrate an example of a laptop in a closed position and open position, respectively, having two of the disclosed hinge mechanisms on each end or side, in accordance with an embodiment.

FIG. 31 illustrates an example of the laptop of FIGS. 29 and 30 with its bottom portion and top portion relatively rotated and configured for disengagement, in accordance with an embodiment.

### DETAILED DESCRIPTION OF THE PREFERRED EMBODIMENT(S)

Disclosed herein is a removably interlocking barrel hinge assembly that is designed to connect two parts together for relative rotation or pivoting, while also allowing for disconnection or separation of the two parts.

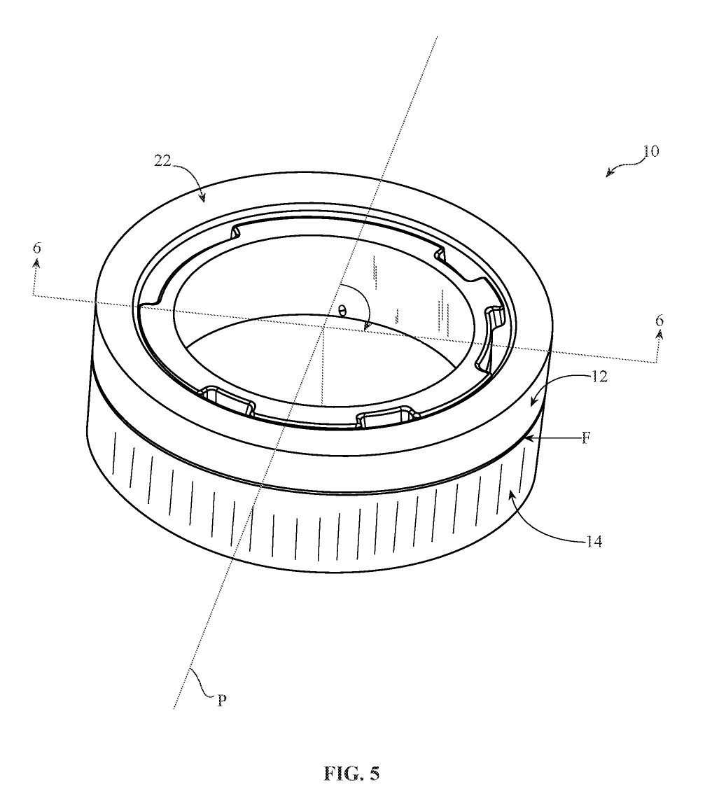

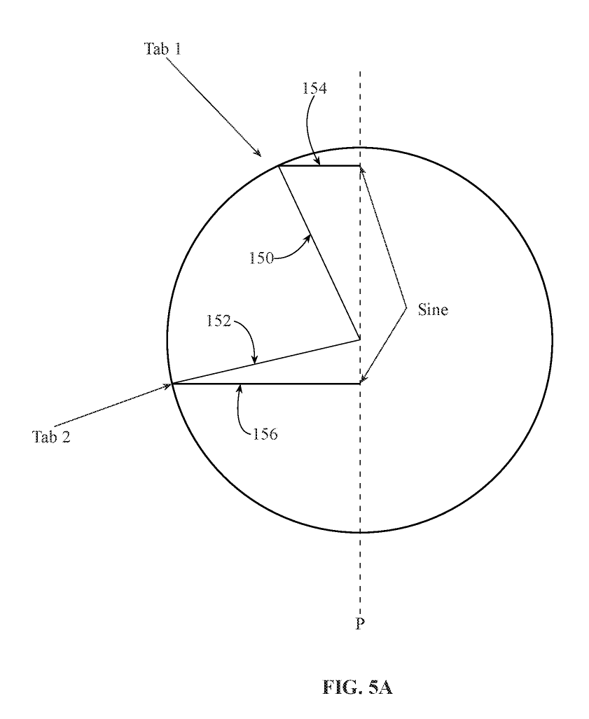

In accordance with an embodiment, the barrel hinge assembly 10 (see assembly in FIG. 5) is formed of two parts or connectors, each of which have a set of interlocking tabs and recesses that align with those of the opposite part. In general, the tabs align in a particular position (or positions) with opposite recesses to allow the parts or connectors to be slotted together or pulled apart for easy assembly or disassembly. In other positions, the tabs and recesses do not align, causing at least partial overlap of the adjacent tabs, and thus the connectors cannot be separated or detached from one another in an axial direction, but still may be rotated.

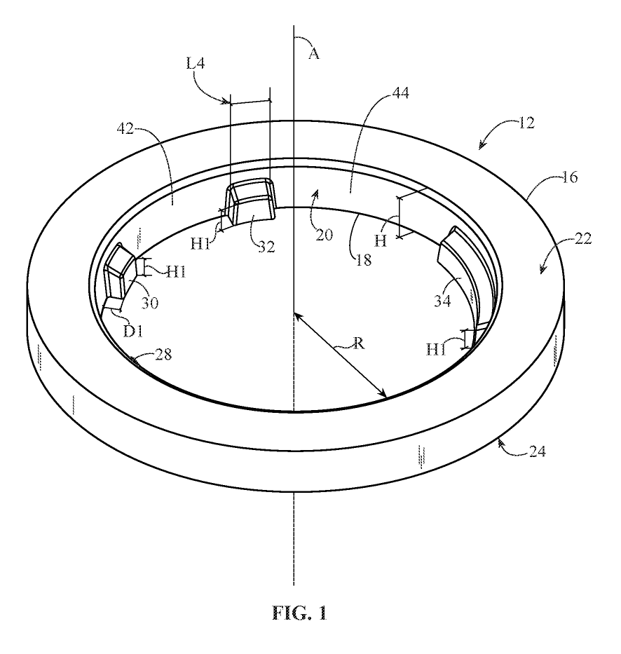

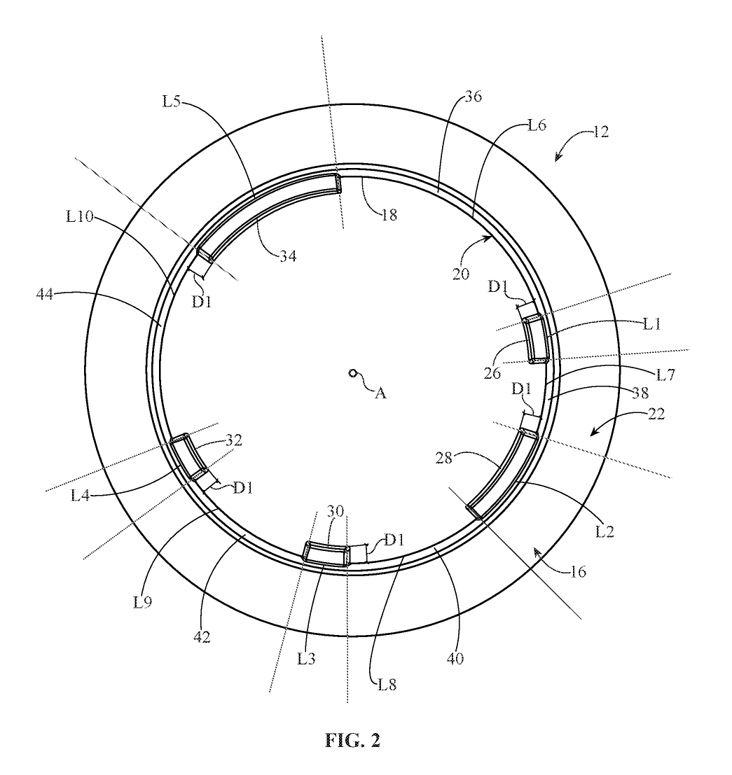

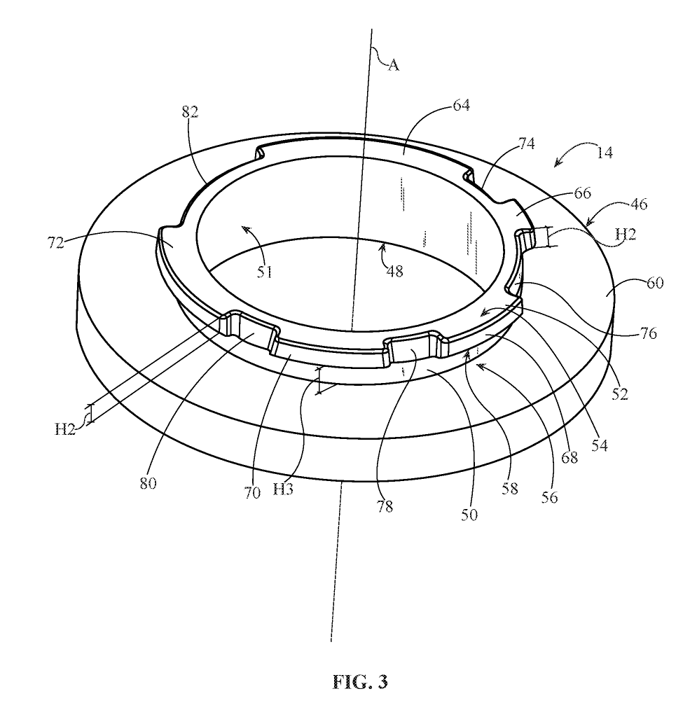

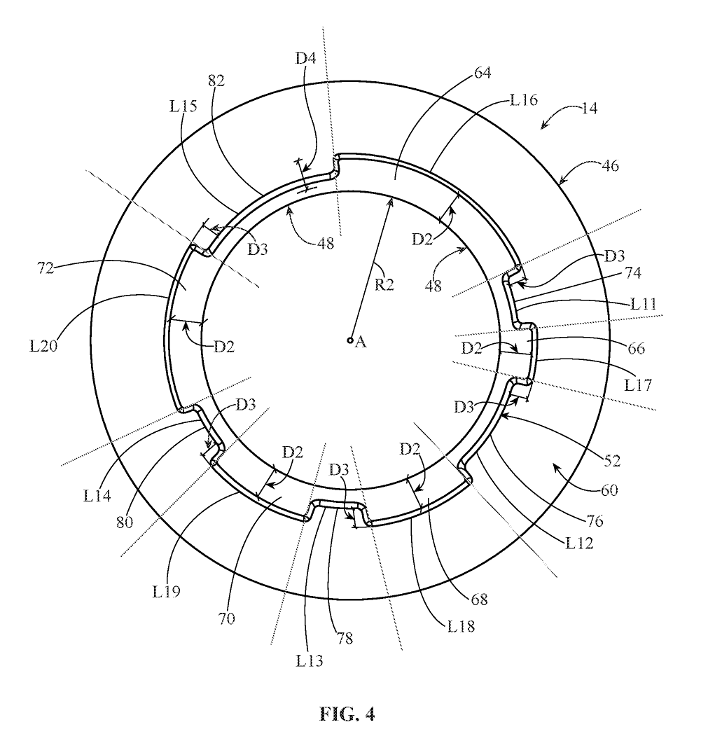

The barrel hinge assembly 10 includes a first connector 12 (see FIGS. 1 and 2) and a second connector 14 (see FIGS. 3 and 4). As will be understood by one of ordinary skill in the art, the connectors 12 and 14 may be a part of, or attached to, parts that are designed for pivoting or rotation relative to one another. Examples of devices implementing the herein disclosed design are described later.

The first connector 12 has a first body 16 with a first opening 18 therethrough, as shown in FIGS. 1 and 2, for example. The first body 16 has an inner wall 20 surrounding the opening 18. The opening 18 has a radius R (see FIG. 1) measured from a center axis A (which is the same axis for which the first connector 12 may rotate about, as described further below). The inner wall 20 has a height H (see FIG. 1) that extends in an axial direction between a top surface 22 and a bottom surface 24 of the connector 12. As shown in FIG. 2, multiple tabs 26, 28, 30, 32, and 34 are spaced circumferentially around the inner wall 20 of first connector 12. Multiple recesses 36, 38, 40, 42, and 44 (or spaces) are provided between the tabs 26, 28, 30, 32, and 34 about the circumference of the inner wall 20. Each of the recesses 36, 38, 40, 42, and 44 has sides and a back (e.g., surface of inner wall 20). Each of the tabs 26, 28, 30, 32, and 34 of first connector 12 has a bottom, sides, and a top. Each tab 26, 28, 30, 32, and 34 projects from the inner wall 20 into the opening 18 at a depth. The depth of each of the tabs 26, 28, 30, 32, and 34 is measured from a proximal edge at the inner wall 20 to a distal edge in the opening 18. In accordance with an embodiment, each of the tabs 26, 28, 30, 32, and 34 of the first connector 12 has the same depth D1.

It can also be said that each of the recesses 36, 38, 40, 42, and 44 have a depth that is measured from the distal edge of the tabs to the inner wall 20 of the opening 18. In accordance with an embodiment, each of the recesses 36, 38, 40, 42, and 44 has the same depth D1.

Each tab 26, 28, 30, 32, and 34 of the first connector 12 also has a height as measured from the bottom surface 24 (or perimeter of the inner wall 20) to the top of the tab 26, 28, 30, 32, and 34 (towards the top surface 22). In accordance with an embodiment, each of the tabs 26, 28, 30, 32, and 34 of first connector 12 have the same height H1 (see FIG. 1).

Further, each tab 26, 28, 30, 32, and 34 and recess 36, 38, 40, 42, and 44 of the first connector 12 also has a circumferential length. The “circumferential length” of each tab as defined herein is a length or distance as measured from one side of a tab to the other side (e.g., across a bottom or the top). The “circumferential length” of each recess as defined herein is a length or distance as measured between the sides of adjacent tabs about the opening 18. The circumferential length of each tab and recess may be described, in one embodiment, as being substantially similar or equal to an arc length (e.g., measured along the inner wall 20). As representatively illustrated in FIG. 2, each of the tabs 26, 28, 30, 32, and 34 of first connector 12 have a respective circumferential length L1, L2, L3, L4, and L5, and each of the recesses 36, 38, 40, 42, and 44 have a respective circumferential length of L6, L7, L8, L9, and L10.

Generally, the tabs may be substantially rectangular or polygonal in shape. however, it should be noted that in some embodiments, the shape of the tabs may alter depending on the manufacturing method used. For example, the tabs may result in a trapezoidal shape to accommodate draft angles on the parts when the hinge assembly is molded (e.g., to accommodate use of a slide inside the mold to release the undercut such that the slide is released cleanly). Further, machining may be used after molding to alter the shape of the tabs.

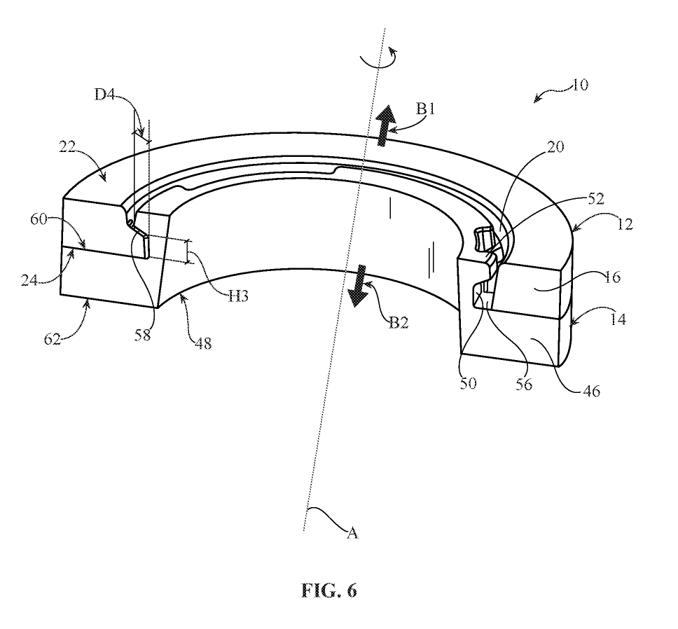

The second connector 14 has a second body 46 with a second opening 48 therethrough, as shown in FIGS. 3 and 4, for example. The second body 48 has an inner wall 51 surrounding the opening 48. The opening 48 has a radius R2 (see FIG. 4) measured from a center axis A (which is the same axis for which the second connector 14 may rotate about, when connected to the first connector 12, as described in further detail below). The second body 46 has an outer wall 50 with a shoulder 52 extending therefrom and a receiving slot 56. The shoulder 52 has a top surface 54 and a bottom surface 58. The receiving slot 56 is formed between an upper surface 60 of the body 46 and the bottom surface 58 of the extended shoulder 52. The receiving slot 56 is configured for receipt of the tabs 26, 28, 30, 32, and 34 of the first connector 12, and, when the hinge assembly 10 is assembled, the slot 56 allows for sliding movement of the tabs 26, 28, 30, 32, and 34 in a sliding direction (e.g., when at least one of the bodies 16 and/or 46 is rotated about axis A). As can be seen in FIG. 6, the receiving slot 56 has a height H3 and a depth D4. The height H3 of the receiving slot 56 is defined as the distance between the upper surface 60 and the bottom surface 58 of the shoulder 52. The depth D4 of the receiving slot 56 is defined as the length or distance between a plane in line with a front surface of the shoulder 52 and an outer surface of the outer wall 50.

When the hinge assembly 10 is assembled or connected, the shoulder 52 of the second connector 14 is designed to limit motion of the tabs 26, 28, 30, 32, and 34 of the first connector 12 in an axial direction away from and apart from the second connector 14, by overlapping the tabs 26, 28, 30, 32, and 34 in multiple configurations, so that the hinge 10 does not fall apart or disconnect accidentally. As shown in FIG. 4, multiple tongues or tabs 64, 66, 68, 70, and 72 are spaced circumferentially around the shoulder 52 of second connector 14. Multiple recesses 74, 76, 78, 80, and 82 (or spaces) are provided between the tabs 64, 66, 68, 70, and 72 and spaced about the circumference of the shoulder 52. The recesses 74, 76, 78, 80, and 82 correspond in number to the tabs 26, 28, 30, 32, and 34 of the first connector 12, and are each formed of a shape that is complimentary to the tabs 26, 28, 30, 32, and 34, respectively. Such a configuration allows for alignment of the tabs 26, 28, 30, 32, and 34 with the recesses 74, 76, 78, 80, and 82 in at least one position for disassembly of the hinge, as explained further below.

Each of the tabs 64, 66, 68, 70, and 72 of second connector 14 has a bottom, sides, and a top. Each of the recesses 74, 76, 78, 80, and 82 has sides and a back. Each of the recesses 74, 76, 78, 80, and 82 projects into the shoulder 52 at a depth to distinguish and form the sides of the tabs 64, 66, 68, 70, and 72. A depth of each of the tabs 64, 66, 68, 70, and 72 is measured from an edge at the opening 48 to a distal edge of the shoulder 52. In accordance with an embodiment, each of the tabs 64, 66, 68, 70, and 72 of the second connector 14 has substantially the same depth D2 (see FIG. 4).

It may also be said that each of the recesses 74, 76, 78, 80, and 82 have a depth D3 (see FIG. 4) that is measured from the distal edge of the shoulder 52 towards the opening 48 to an inner surface. In accordance with an embodiment, each of the recesses 74, 76, 78, 80, and 82 has a depth D3 that is substantially similar to or equal to the depth D1 of the tabs 26, 28, 30, 32, and 34 of the first connector 12 (e.g., D3˜=D1). In another embodiment, the depth D3 of the recesses 74, 76, 78, 80, and 82 is less than the depth D1 of the tabs 26, 28, 30, 32, and 34 (D3<D1).

Each tab 64, 66, 68, 70, and 72 of the second connector 14 also has a height H2 (see FIG. 3) as measured from the bottom surface 58 of the shoulder 52 to its top surface 54. In accordance with an embodiment, each of the tabs 64, 66, 68, 70, and 72 of the second connector 14 has the same height H2.

In accordance with an embodiment, the height H2 of each of the tabs on the second connector 14 may be determined based on the height H1 of each of the tabs on the first connector 12, or vice versa. Similarly, in some embodiments, the height H3 and/or the depth D4 of the receiving slot 56 may be based on the height H1 and/or depth D1 of the tabs of the first connector 12, or vice versa.

In accordance with one embodiment, each of the tabs 64, 66, 68, 70, and 72 of the second connector 14 has a height H2 that is substantially similar to or equal to the height H1 of the tabs 26, 28, 30, 32, and 34 of the first connector 12 (e.g., H2˜=H1). In another embodiment, the height H2 of the tabs 64, 66, 68, 70, and 72 is less than the height H1 of the tabs 26, 28, 30, 32, and 34 (H2<H1). In yet another embodiment, the height H2 of the tabs 64, 66, 68, 70, and 72 is greater than the height H1 of the tabs 26, 28, 30, 32, and 34 (H2>H1).

Further, each tab 64, 66, 68, 70, and 72 and recess 74, 76, 78, 80, and 82 of the second connector 14 also has a circumferential length. As representatively illustrated in FIG. 2, each of the recesses 74, 76, 78, 80, and 82 of the second connector 14 have a respective circumferential length of L11, L12, L13, L14, and L15 and each of the tabs 64, 66, 68, 70, and 72 have a respective circumferential length L16, L17, L18, L19, and L20.

In accordance with an embodiment, the circumferential lengths of the recesses 74, 76, 78, 80, and 82 in the second connector 12 compliment the circumferential lengths of the tabs 26, 28, 30, 32, and 34 in the first connector 12. For example, the recesses 74, 76, 78, 80, and 82 may have lengths that are slightly larger than the lengths of the tabs 26, 28, 30, 32, and 34, such that the tabs may be aligned with and received through the recesses to move below an area of the shoulder 52 and into the slot 56. In an embodiment, L11 compliments L1, L12 compliments L2, L13 compliments L3, L14 compliments L4, and L15 compliments L5.

FIG. 5 illustrates an example of the connectors 12, 14 as assembled to form the disclosed hinge assembly 10. When assembled, the first opening 18 and the second opening 48 of the connectors 12, 14 are axially aligned along axis A. As shown in greater detail in the cross section of FIG. 6, when the hinge assembly 10 is assembled (i.e., the connectors 12, 14 are connected together), the inner wall 20 of first connector 12 faces the outer wall 50 of the second connector 14. Further, the tabs 26, 28, 30, 32, and 34 of the first connector 12 are received in slot 56 underneath the shoulder 52 of the second connector 14. Either one of, or both of, the first connector 12 and the second connector 14 is configured for rotation about the axis A relative to the other connector. During rotation, the tabs 26, 28, 30, 32, and 34 of the first connector 12 are moved relatively in the sliding direction within the slot 56 of the second connector 14 and are secured at least part by the shoulder 52, thereby preventing separation of the first and second connectors 12, 14 in the axial direction. More specifically, the placement of the tabs 64, 66, 68, 70, and 72 and recesses 74, 76, 78, 80, and 82 along shoulder 52 of the second connector 14 are designed to substantially overlap the tabs 26, 28, 30, 32, and 34 of the first connector 14 during rotation to prevent detachment thereof.

However, as previously noted, the tabs and recesses of the connectors 12, 14 are designed to be opposite or complimentary to one another, such that, when the tabs 26, 28, 30, 32, and 34 of the first connector 12 are aligned with the recesses 74, 76, 78, 80, and 82 in the shoulder 52 of the second connector 14 in a disassembly position (e.g., see FIG. 7), the first connector 12 and second connector 14 are configured for disconnection in the axial direction via movement away from each other along the axis A (see arrows B1 and B2 in FIG. 6).

The hinge assembly 10 may be assembled (or re-assembled) by aligning the tabs and recesses of the connectors (FIG. 7) in a complimentary fashion. The tabs and recesses of one connector align in the recesses and tabs in the opposite connector, allowing the connectors to be moved or pushed together in the axial direction (e.g., towards each other along axis A). FIG. 7 illustrates an example of the alignment of the connectors 12, 14 when assembled yet unlocked. After alignment and assembly, at least one of the connectors is turned or rotated relative to the other such that the tabs and recesses overlap one another and thus lock the connectors 12, 14 in an interlocking and engaging fashion. FIG. 6 shows that when the connectors 12, 14 are locked together, in addition to the inner wall 20 of first connector 12 and the outer wall 50 of the second connector 14 facing each other, the tabs 26, 28, 30, 32, and 34 of the first connector 12 are received and configured for relative movement within the receiving slot 56. Also, in one embodiment, the outer surfaces (top and bottom surfaces) of each of the connectors 12, 14 may be aligned on the same plane and substantially flush with one another.

To disconnect the hinge, the connectors are rotated relative to one another such that the tabs and recesses of one connector align with the recesses and tabs of the other connector. In one embodiment, one part is rotated relative to the other part. Once aligned, the connectors can be moved or pulled away from each other in the axial direction (along axis A) and separated.

Referring now more specifically to additional features relating to the tabs of each of the connectors 12, 14, and the disclosed design thereof, in order to determine and optimize the layout of the tabs on the connectors 12 and 14 as shown in the exemplary embodiment in FIGS. 1-6 (as well as FIGS. 7-11, described later), several criteria were considered, including, but not limited to:
No more than five (5) tabs to be provided on each of the connectors, e.g., for ease of manufacturing and maintaining strength of the tabs;
Hinge parts may be opened/separated in a first position (e.g., at an angle of 0° relative rotation)
(Optional) Hinge parts may be securely locked for a total of approximately 180 degrees of relative rotation (e.g., angles of 20° to 200°); and
Each tab on the connectors would have a reasonably included angle/angular length (i.e., circumferential length), e.g., for ease of manufacturing. In an embodiment, each tab would have at least 2 (contiguous) segments.

During design optimization, the opening of each hinge connector (e.g., openings 18 and 48) was divided into N segments of 360°/N each. For each segment, it was determined that tabs would be on one connector, with a corresponding recess on the opposite connector, and vice versa, so that the two connectors are able to fit together. A number of initial candidate solutions were considered using the above noted criteria.

In accordance with one embodiment, disclosed design can be represented numerically as a string of numbers, where the numbers alternate between the relative size of the tab and the relative size of the space. As an example, with reference to the first connector 12 in FIG. 2, if the perimeter of the opening 18 has a total circumferential length of forty (40), relative sizes or circumferential lengths of the recesses and tabs are represented (going clockwise from a twelve o'clock position) as: L6 of recess 36=8/40, L1 of tab 26=2/40, L7 of recess 38=2/40, L2 of tab 28=4/40, L8 of recess 40=4/40, L3 of tab 30=2/40, L9 of recess 42=4/40, L4 of tab 32=2/40, L10 of recess 44=6/40, and L5 of tab 34=6/40, where each number “N” of N/40 represents the relative size of the tab or space.

Similarly, with reference to the second connector 14 in FIG. 4, the relative size of the tabs and recesses are represented (going clockwise from a twelve o'clock position) as: L16 of tab 64=8/40, L11 of recess 74=2/40, L17 of tab 66=2/40, L12 of recess 76=4/40, L18 of tab 68=4/40, L13 of recess 78=2/40, L19 of tab 70=4/40, L14 of recess 80=2/40, L20 of tab 72=6/40, and L15 of recess 82=6/40, where each number “N” of N/40 represents the relative size of the tab or recess.

In accordance with an embodiment, keeping the previously noted criteria in mind, the minimum number of tabs on each of the connectors in the sequence is two (2), and a sum of the numbers, or total circumferential length of the openings (18 and 48), is less than about 50.

In order to test each particular candidate solution/configuration, a fitness score was devised. Generally, the fitness score may depend on an application of the hinge (e.g., in a specific device), and so may be different for different incarnations or implementations.

The criteria considered for testing purposes was a hinge configured to be robust and secure for relative rotations of 20° to 200° (with 0 degrees being an assembly position) (i.e., may be securely locked for a total of approximately 180 degrees of relative rotation). For each relative rotation of “n” equal rotations in this range, a calculation was made to determine how securely fastened the hinge components were. For example, such calculation may include determining how many of the tabs from each connector are overlapping, and/or how much overlap occurred. The effect of an overlapping tab depends on the direction in which the hinge is being pried apart.

For example, if a force (arrow F in FIG. 5) is attempted to pry the hinges apart around the 12 o'clock-6 o'clock axis of rotation (call this the “pry apart axis”, shown as axis P in FIG. 5), overlapping tabs at 3 o'clock and 9 o'clock will prevent this more effectively than overlapping tabs at 12 o'clock and 6 o'clock. This is because overlapping tabs that are 90 degrees from the pry apart axis P give an optimal amount of support, whereas tabs that are parallel (or touching) the pry apart axis P may not offer as much support in preventing the two parts 12, 14 from being pried apart. In general, overlapping tabs were scaled by a factor of the sine (see FIG. 5A) of the angle θ (see FIG. 5) between the pry apart axis P and the tab (measured from the center of the hinge). Prying apart is resisted by the torque, which is the force (F) times the straight line distance. The “straight line distance” is the sine of the angle θ (i.e., the angle between one set of overlapping tabs and the pry apart axis P) times the radius R. For example, referring to FIG. 5A, line 150 and line 152 represent positions of overlapping tabs (line—tab 1, line—tab 2). Lines 154 and 156—which extend to the pry apart axis P—are the distances which are calculated by using the sine of the angle θ. The location where tab 2 is located would provide more support with respect to the pry apart axis P, while tab 1 may be scaled by some factor. Accordingly, since the radius R is constant, the resistance to prying apart is proportional to the overlap and the sine of the angle θ.

The robustness of a particular relative rotation/position of each hinge design/candidate solution was then determined by calculating an overlap factor for each pry apart axis, e.g., by scaling the overlapping tabs by the sine of the angle between the pry apart axis and the overlapped tab. By calculating the overlap factor for each side of the pry apart axis separately, it ensures that the hinge cannot slip out of one side of the pry apart axis, despite being securely held by the other side. This overlap factor is calculated for all possible pry apart angles. The robustness of the relative rotation of the hinge is then the minimum overlap factor found.

The overall fitness score is the minimum robustness of all the relative rotations that are of interest (e.g., in this case, rotations between 20° to 200°).

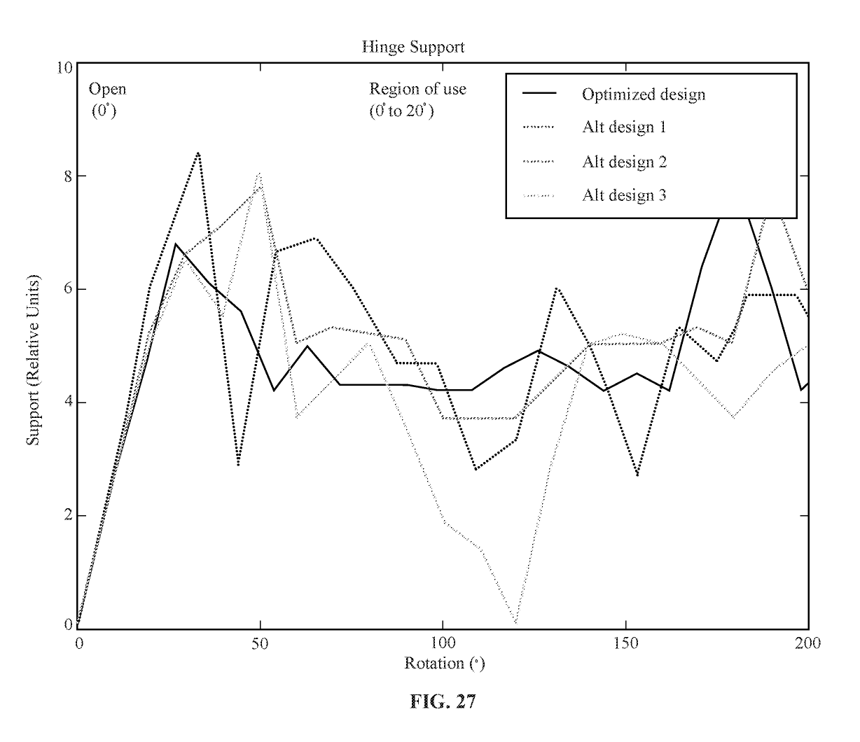

The fitness score for a number of designs or candidate solutions was measured by implementing the above described steps in algorithm implemented in a computer that has a processor or controller configured to perform the algorithm steps and tests to measure their fitness. Each solution is varied in a random way (e.g., changing the N number of segments, and/or the relative size of the tabs). Each mutation was measured for fitness using the algorithm until optimized solutions were found (and others discarded). FIG. 27 is a graph showing support and rotation measurement results related to optimizing the design of the disclosed hinge, including results for a number of candidate solutions, in accordance with an embodiment.

The hinge assembly 10 as shown in FIGS. 1-6, for example, is an optimized solution found during testing, and in compliance with the previously noted criteria, which represented by the previously noted sequence of relative tab sizes as [8, 2, 2, 4, 4, 2, 4, 2, 6, 6 (going clockwise on FIG. 2 and/or FIG. 4—for a total circumferential length of forty (40)]. In accordance with one embodiment, the hinge assembly 10 includes tabs that are not evenly distributed from or spaced circumferentially around inner walls of the connectors 12, 14. An example of this is shown in FIG. 2, for example, which shows that the tabs 26, 28, 30, 32, and 34 of the first connector 12 are unevenly spaced. Similarly, the tongues or tabs on second connector 14 may also be unevenly spaced circumferentially around the shoulder 52. In one embodiment, the distribution of the tabs on the second connector 14 about the shoulder 52 depends on the distribution of the tabs 26, 28, 30, 32, and 34 of the first connector 12, or vice versa.

In accordance with an embodiment, such as previously described with respect to FIGS. 1-4, at least one tab on each of the connectors 12, 14 has a different circumferential length as compared to other tabs. For example, if an embodiment includes two tabs, one of the two has a differential circumferential length. In an embodiment that includes at least three tabs, at least one of the tabs has a different circumferential length as compared to the other two tabs. In one embodiment, the other two tabs may have different or similar lengths. In another embodiment that includes at least four tabs, at least one of the tabs has a different circumferential length as compared to the other three tabs. In one embodiment, each of the other tabs may have different or similar circumferential lengths. In another embodiment, at least two of the tabs have similar circumferential length, while the remaining tab(s) have a different circumferential length as compared to the at least two tabs.

In accordance with one embodiment, the first connector 12 and second connector 14 each has no more than five tabs, with at least one tab having a different circumferential length as compared to the other tabs. In an embodiment, each connector 12 and 14 has no more than five tabs, and at least two of the no more than five tabs have similar circumferential length and at least one other tab has a differential circumferential length. In another embodiment, at least three of the five tabs have similar circumferential length.

The connectors 12 and 14 illustrate an example of such an embodiment including 5 tabs with at least one tab having a different circumferential length as compared to the others. More specifically, the illustrated embodiment as shown in FIGS. 1-6 includes at least three tabs of similar length on first connector 12 in addition to the one of differential circumferential length. For example, referring to the first connector 12 of FIG. 2, L1 of tab 26, L7 of recess 38=2/40, L3 of tab 30, and L4 of tab 32 are of similar or the same length (e.g., L1=L3=L4) (e.g., 2/40), while L5 of tab 34 is different in length as compared to those tabs (e.g., larger, L5>L1) (e.g., 6/40).

In accordance with one embodiment, the first connector 12 and second connector 14 each has no more than five recesses, with at least one recess having a different circumferential length as compared to the other recesses. In an embodiment, each connector 12 and 14 has no more than five recesses, and at least two of the no more than five recesses have similar circumferential length and at least one other recess has a differential circumferential length. In another embodiment, at least three of the five recesses have similar circumferential length.

FIGS. 7-11 illustrate examples of the assembled hinge assembly 10 showing the first and second connectors 12 and 14 in a number of different positions. For example, FIG. 7 illustrates the connectors 12, 14 in an assembled and unlocked position (e.g., at 0 degrees of relative rotation), wherein the tabs of the first connector 12 are aligned with the recesses of the second connector 12. In this position, the hinge can be pulled apart; i.e., first and second connectors can be disassembled. FIGS. 8-11 illustrate other positions of the tabs and recesses of the connectors 12, 14 during relative rotation. The relative positioning of the first and second in each of FIGS. 8-11 prevents disconnection of the hinge parts/connectors 12, 14 because of the positioning and alignment of the tabs and recesses of the connectors. For example, to lock the connectors 12, 14 together, one of the connectors (e.g., second connector 14) may be rotated relative to the other connector (e.g., first connector 12). Accordingly, at least a majority of the tabs on the first connector 12 are covered by and/or at least partially overlapped by the tongues/tabs on the second connector. The at least partial overlap of at least a majority of the tabs of the second connector with those of the first connector thereby prevent axial movement of the connectors and thus prevent disconnection of the hinge.

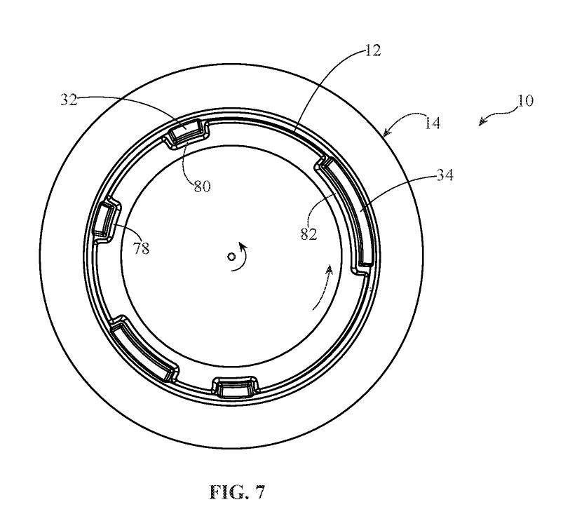

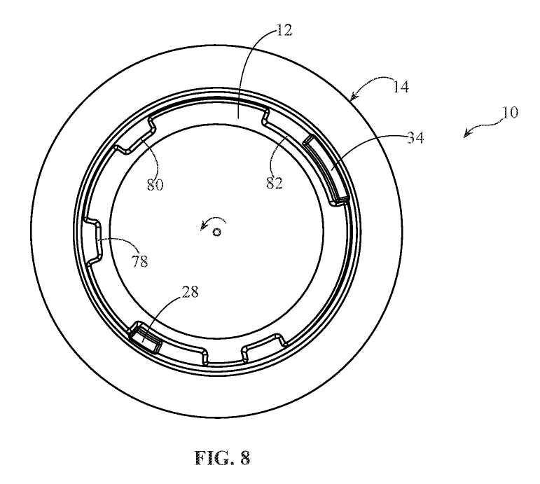

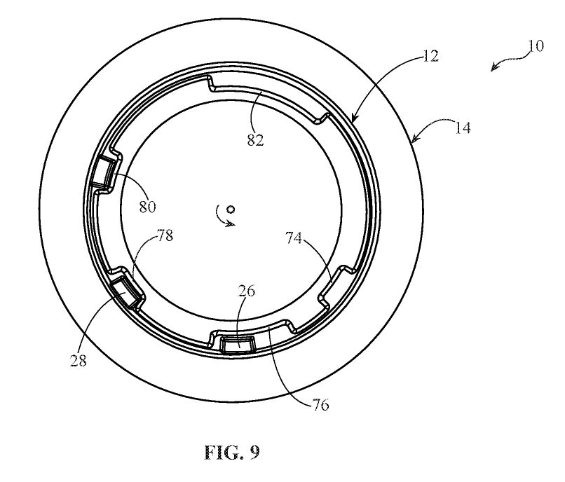

In one embodiment, all of the tabs of the first connector are at least partially overlapped by the tabs of the second connector (e.g., see FIG. 8). In another embodiment, a majority of the tabs of the first connector are at least partially overlapped by the tabs of the second connector (e.g., see FIG. 9, FIG. 10, and FIG. 11).

In an embodiment, the alignment of the tabs of the first connector with the recesses in the shoulder of the connector may be referred to as the connectors being at 0 degrees of relative rotation. In the illustrated embodiment, after they are connected, the first connector and the second connector are configured for relative rotation up to approximately 180 degrees (inclusive). In one embodiment, to secure the connectors 12, 14 together after alignment at 0 degrees, the connector(s) 12, 14 may be turned or rotated up to 20 degrees (e.g., rotate the second connector 14 relative to the first connector 12) to secure the hinge assembly 10 in its assembled position. As such, if the first and second connectors are designed for 180 degrees of relative rotation, at least one of the connectors 12, 14 may be rotated between 20 degrees and approximately 200 degrees, in accordance with an embodiment.

However, the relative rotation of the connectors is not intended to be limited to 180 degrees. In another embodiment, the first connector 12 and the second connector 14 are configured for relative rotation up to approximately 90 degrees (inclusive) before alignment of the tabs and recesses in the connectors. In yet another embodiment, the first connector 12 and the second connector 14 are configured for relative rotation up to approximately 270 degrees (inclusive).

Accordingly, as compared to known hinges, for example, the herein disclosed removably interlocking barrel hinge assembly 10 has only two components, i.e., first connector 12 and second connector 14, and does not require any additional components or further clips, pins, or other locking components to secure the hinge assembly together. Further, the disclosed hinge 10 is easier to assemble and disassemble, while still remaining robust and compact throughout its rotation or pivoting motion. The disclosed design of the hinge 10 further takes advantage of the fact that intricate geometries may be molded into each part, with small incremental cost.

The design of the hinge components as illustrated and described herein are not intended to be limited. The hinge assembly 10 may have a different number of tongues, bigger tongues, or a different fitness score. e.g., there's some particular force that it needs to resist and therefore the fitness score is designed to resist that particular force.

Although FIGS. 1-11 illustrate the bodies 16 and 46 of the connectors 12 and 14 as being circular or ring-shaped, it should be understood that such a configuration is not intended to be limiting. Rather, the openings 18 and 48 and tabs and recesses as described may be provided on a number of different shaped bodies or parts, and may or may not be incorporated into a device.

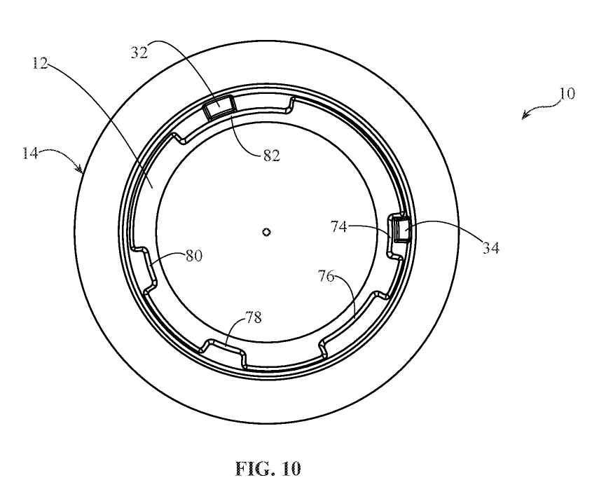

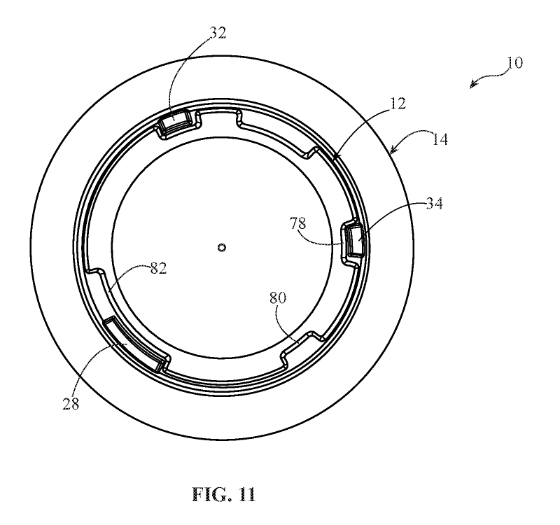

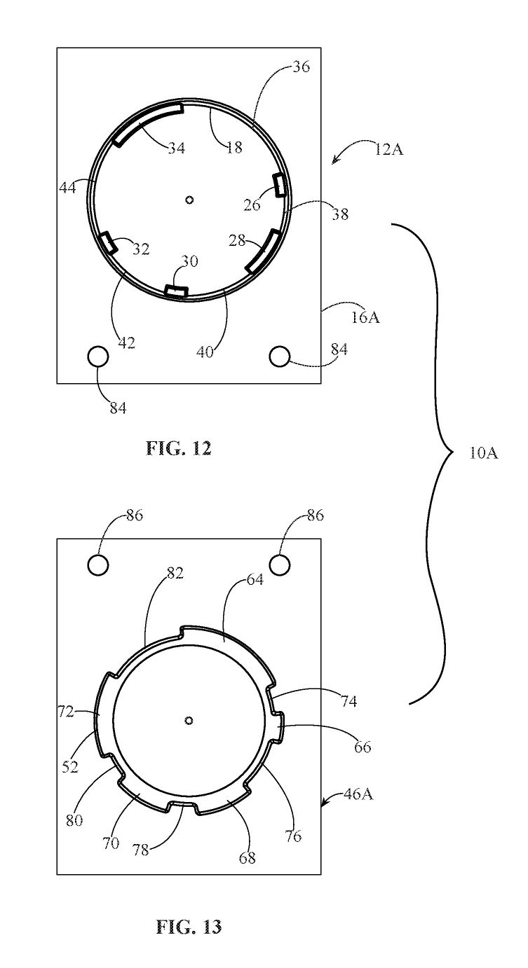

FIGS. 12-17 illustrate alternate body shapes and configurations in hinge assemblies utilizing the tabs, recesses, and openings as describe above with respect to FIGS. 1-11. For simplicity purposes only, similar parts as described and noted above with respect to FIGS. 1-11 have been labeled with the same reference numbers in FIGS. 12-17. Accordingly, it should also be understood that the features previously noted above with respect to those parts similarly apply to each of the embodiments of FIGS. 12-17 and thus are not necessarily repeated here and below.

FIGS. 12 and 13 illustrate connectors 12A and 14A, respectively, having bodies 16A and 46A in the form of brackets that form a hinge assembly 10A. The brackets may be of rectangular shape, for example. The openings 18 and 48 are provided through the bracket bodies 16A and 46A. The bodies 16A and 46A extend in a plane that is perpendicular to the central axis for rotation, for example. Holes 84 and 86 may be provided in brackets 16A and 46A, respectively, such that the brackets can be attached to part(s) via insertion and securement of fasteners (not shown) (e.g., nails, screws, bolts) through the holes 84 and 86 and into a part. Alternatively, the brackets 16A and 46A may be secured to parts of a device via other connections, including adhesive or welds, for example.

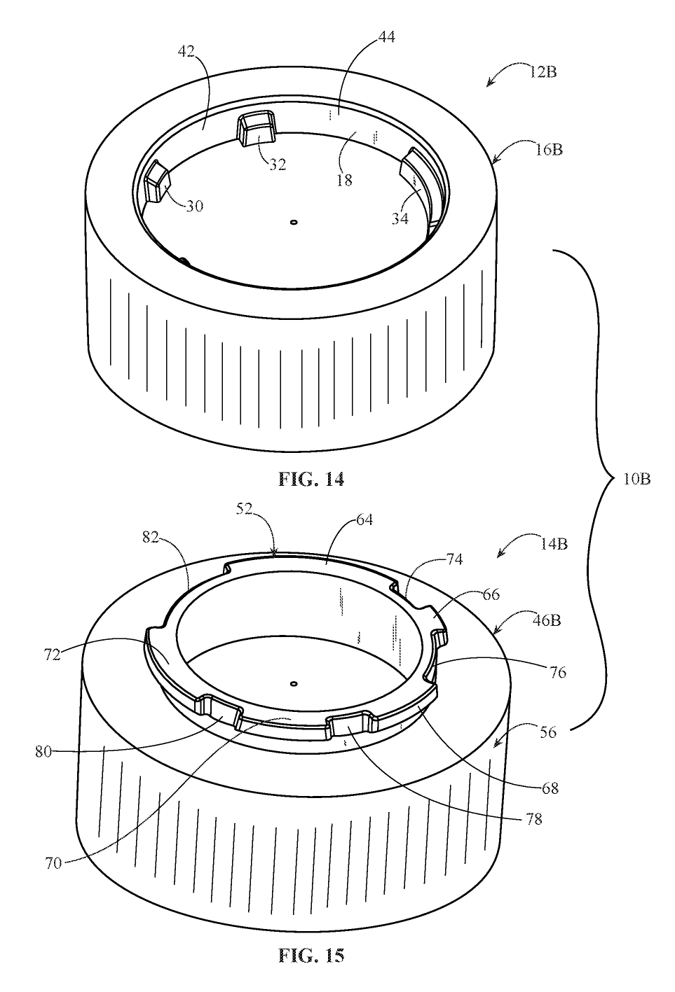

In another embodiment, as illustrated in FIGS. 14 and 15, the connectors 12 and 14 have bodies 16B and 46B in the form of an elongated cylinder or barrel, that form a hinge assembly 10B. The openings 18 and 48 are provided at least through a top portion of the bracket bodies 16B and 46B. In one embodiment, the openings 18 and 48 may extend through the entire cylinder or barrel of the bodies 16B and 46B. The bodies 16B and 46B extend in the axial direction about the central axis for rotation, for example. A second end that is opposite to the ends with the tabs and recesses (e.g., a bottom end) may be attached to parts of a device via any number of connection devices. For example, the brackets 16B and 46B may be secured to parts via adhesive or welds, for example. In one embodiment, the brackets 16B and 46B include threaded portions for a screw connection with a correspondingly threaded part. In another embodiment, the brackets 16B and 46B may receive a portion of the part within their bodies, e.g., snap fit or compression fit therein.

In yet another embodiment, as illustrated in FIGS. 16 and 17, the connectors 12 and 14 have bodies 16C and 46C that each include an angled bracket to form a hinge assembly 10C. As shown, each body 16C and 46C is angled relative to the openings 18 and 48 and extends in the axial direction. Holes 84 and 86 may be provided in brackets 16C and 46C, respectively, such that the brackets can be attached to part(s) via insertion and securement of fasteners (not shown) (e.g., nails, screws, bolts) through the holes 84 and 86 and into a part. Alternatively, the brackets 16C and 46C may be secured to parts of a device via other connections, including adhesive or welds, for example.

The method for manufacturing the herein disclosed hinge 10 may be dependent upon its application and/or how it is intended for use. In accordance with an embodiment, the parts of the hinge 10 may be manufactured or formed using an injection molding process, e.g., by injecting molten material into a mold. In other embodiments, the hinge 10 may be formed via CNC machining or 3D printing.

Materials used to form the hinge 10 may include, but are not limited to, Liquidmetal®, metals such as steel, aluminum, nickel and/or alloys thereof, or plastics.

It should be noted that one of ordinary skill in the art will understand that any reference throughout this description regarding or referring to movement of the connectors 12, 14 of the hinge assembly may also refer to movement of each of the parts of a device associated with each connector. That is, it should be understood that, in embodiments, movement of a first part of a device may cause movement of the first connector and/or movement of a second part of a device may cause movement of the second connector.

Of course, other designs and configurations of the bodies associated with the connectors of the hinge assembly 10 may be implemented, although they may not be described or illustrated here. Further, it should be understood that the connectors may be integrated or incorporated (e.g., molded or formed) into parts of a device, and do not necessarily need to be a separately formed piece for later attachment.

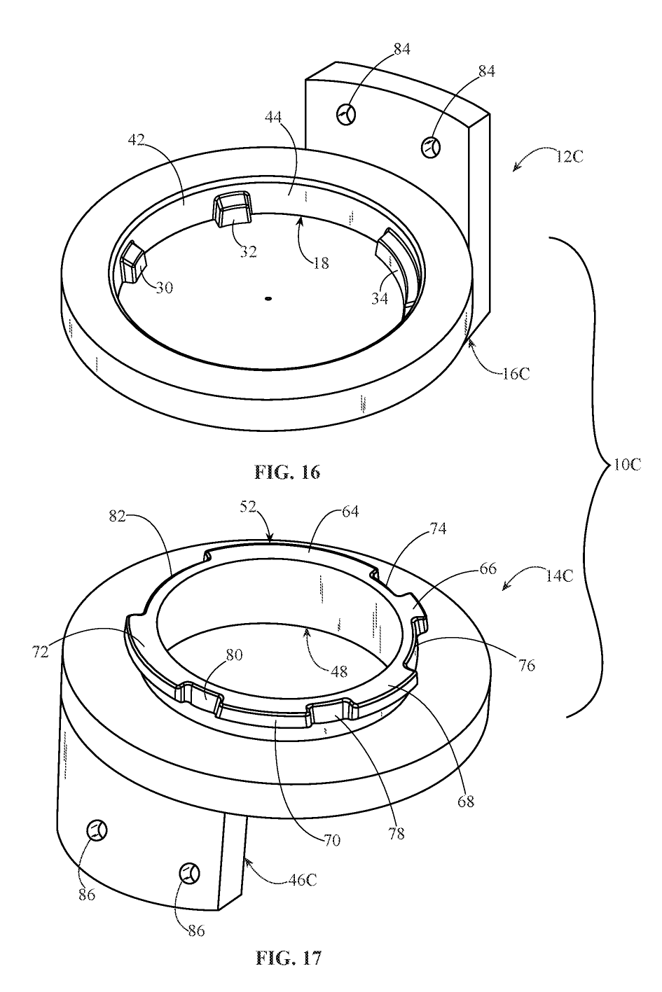

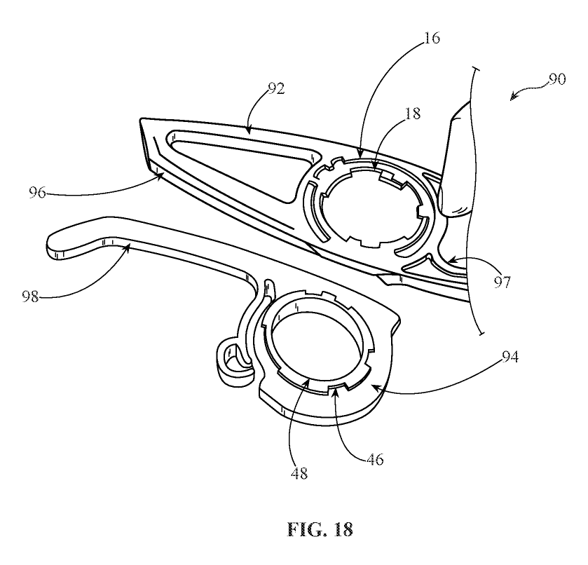

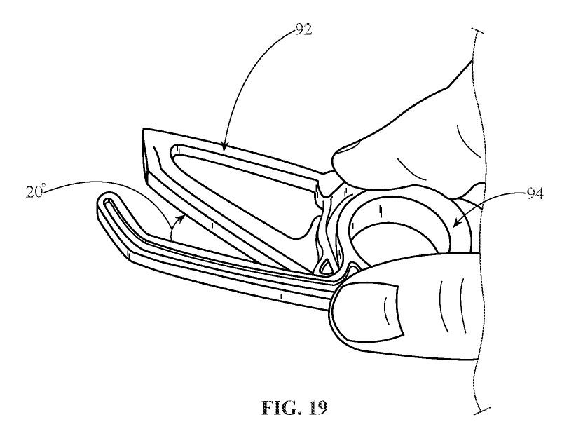

The herein disclosed hinge assembly 10 may be utilized in any number of applications and devices. In one embodiment, such as shown in FIGS. 18-23, the hinge assembly 10 may be implemented in a pocket knife 90. The hinge assembly 10 is provided on the pocket knife 90 which is formed of a first part 92, or body, and a second part 94, or protector, as shown in FIG. 18, that are configured to connect (see FIG. 19) and rotate relative to one another in a number of positions, including one position for use, and another position for disconnection (or connection) of the parts. The first part 92 may include a first part of the hinge, e.g., first connector 12, formed in or on its body (e.g., see FIG. 18 and FIG. 20), as well as a sharpened blade 96 on an extended edge thereof. The first part 92 may also include, for example, first and second grip holes 97 for gripping via receipt of a user's fingers therein. The second part 94 may include a second part of the hinge, e.g., second connector 14, formed in or on its body (e.g., see FIG. 19 and FIG. 21), as well as a cover 98 for protecting the blade 96 on the first part 92, when the knife is not in use.

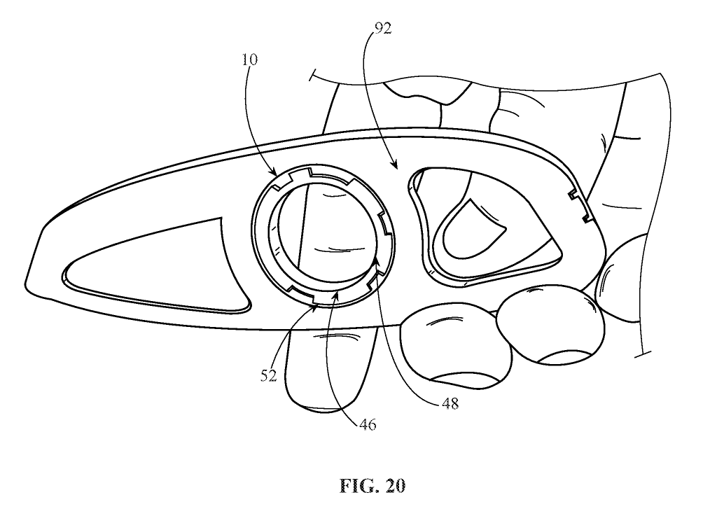

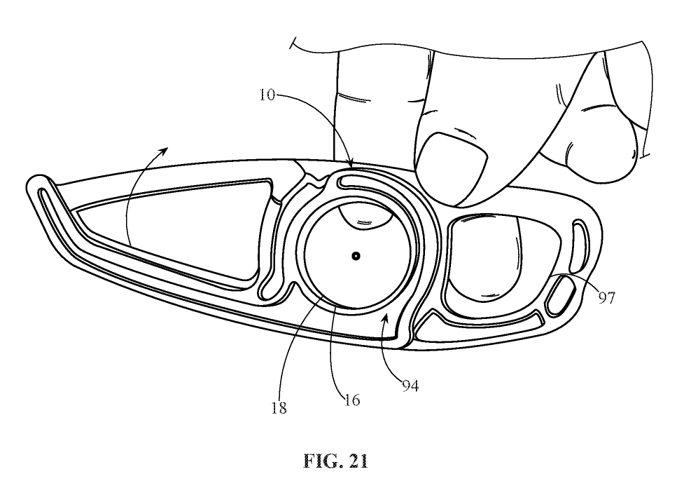

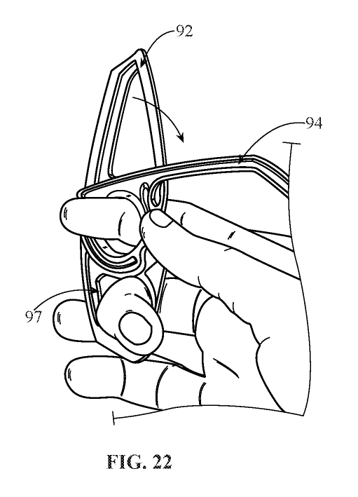

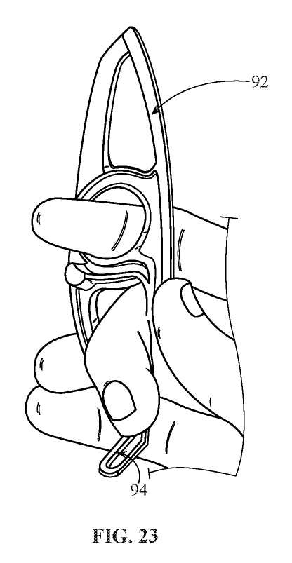

As seen in FIGS. 22-23, an activation button on the blade protector or second part 94 may be grasped by a user's thumb or finger and rotated (e.g., as shown in FIG. 22, pulled towards a user in a backwards direction, or relatively clockwise, or to the right). Once the second part 94 is rotated 180 degrees (e.g., see FIG. 23), the blade 96 on the first part 92 is exposed for use. To cover the blade 96 on the first part 92 and protect a user from injury (such as when the knife is placed in one's pocket), the protector or second part 94 is rotated back in the reverse direction (counterclockwise, or to the left).

To disconnect the parts 92 and 94 of the pocket knife 90, the activation button may be pushed further counterclockwise from the aligned position of FIG. 21, to move the protector or second part 94 to a zero degree position as shown in FIG. 19. In this position, the tabs and recesses are aligned and the parts 92 and 94 may be disassembled and separated.

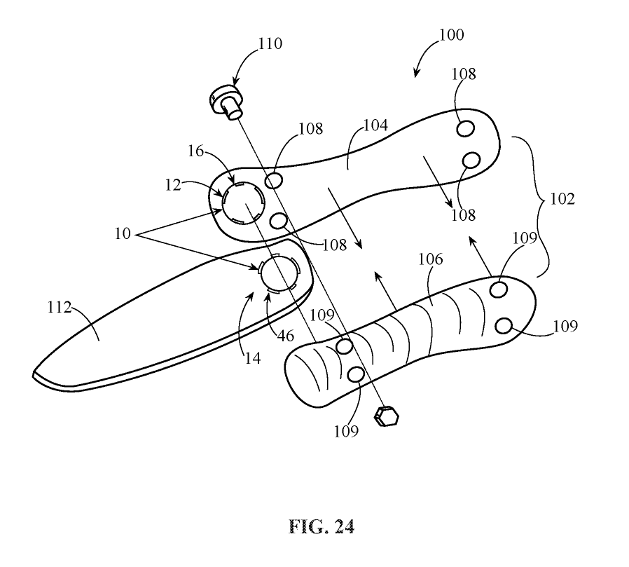

Of course, the use of the herein disclosed hinge on a pocket knife is exemplary only, and not limited to this application. In another embodiment, the disclosed hinge assembly 10 is implemented into parts of a folding knife 100, which is shown in an exploded view in FIG. 24. The folding knife 100 includes, for example, a handle 102 and a blade 112. The handle 102 is formed of a first part 104 and a second part 106 that are connected together via fastening devices 110 (e.g., bolts and nuts) that are inserted through the aligned holes 108 and 109, respectively, for example. The parts 104 and 106, when fastened, are designed to sandwich at least a bottom part of the blade 112 therebetween. The parts 104 and 106 may also include a space for receipt of the blade 112, when rotated approximately 180 degrees, thereby forming a protection device for limiting exposure of the blade 112 when not being used. More specifically, one part of the handle, e.g., the first part 104, may include one part (e.g., first connector 12) of the hinge assembly 10, while a bottom part of the blade 112 includes the corresponding part (e.g., second connector 14) for connection with the first part 104 of the handle 102. Once assembled and connected, the blade 112 is configured to rotate about its bottom relative to the handle 102, approximately 180 degrees, between an in-use position (i.e., the blade 112 extends from the handle 102 and is exposed) and a storage position (i.e., the blade 112 is provided in the space between the parts 104 and 106 and is shielded).

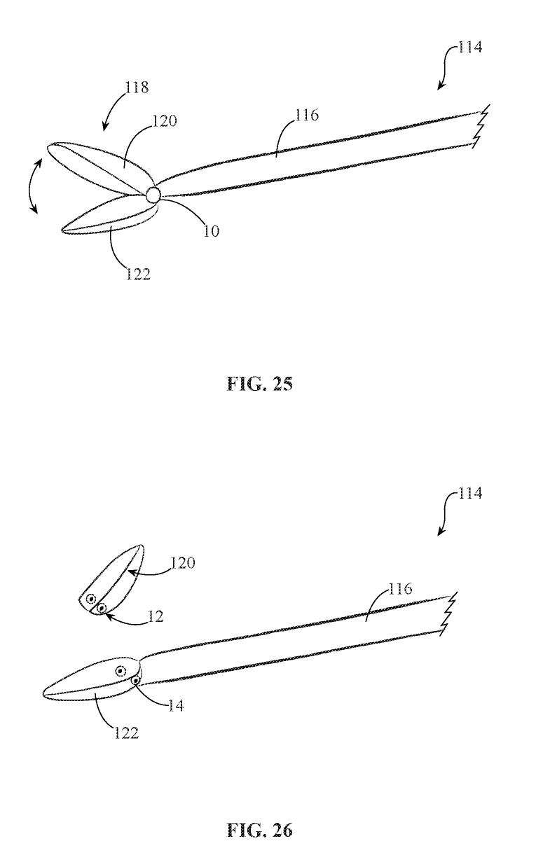

FIGS. 25-26 illustrate another embodiment implementing the hinge assembly 10 in a surgical instrument 114, such as an endoscopic jaw. The instrument 114 includes an elongated handle 116 with a jaw 118 mechanism at one end. The jaw 118 includes a first part 120 and a second part 122 configured for movement relative to one another. One or both of the parts 120 and/or 122 may be actuated via an actuation mechanism to rotate during use, such as shown in FIG. 25. When being assembled (or disassembled), such as shown in FIG. 26, at least one of the parts may be detachable from the instrument 114. For example, the first part 120 of the jaw may include a first connector 12 and the second part 122 may include a second connector 14. However, this is not meant to be limiting.

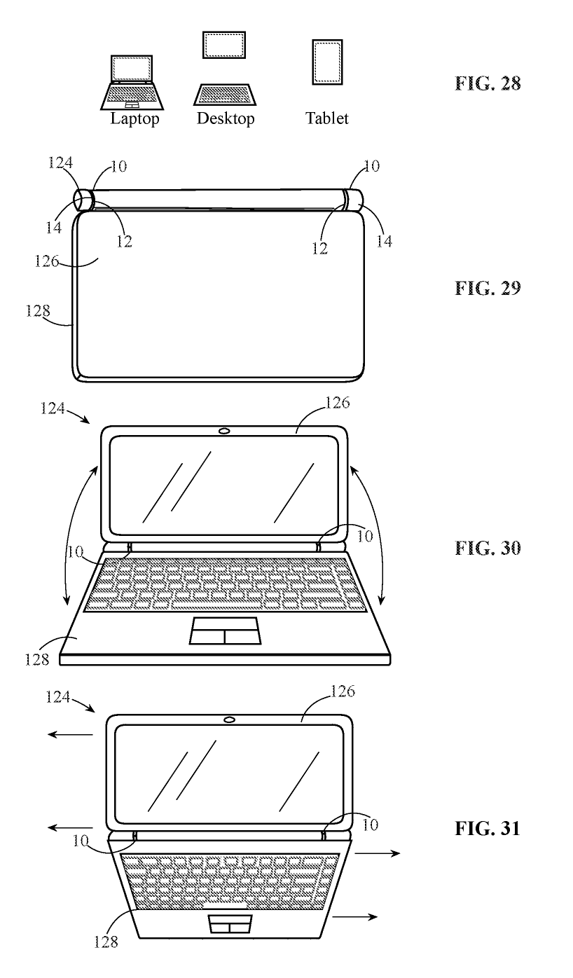

FIG. 28 illustrates exemplary embodiments of electronic devices utilizing the disclosed hinge assembly, in accordance with yet another embodiment. The hinge assembly 10 may be provided in a laptop, a desktop, and/or a tablet, for example, or other portable electronic device. Specifically, FIGS. 29 and 30 illustrate an example of a laptop 124 in a closed position and open position, respectively. Two hinge mechanisms 10 are provided in the laptop 124, one on each end or side. The hinge mechanisms 10 are used to connect a top portion 128 of the laptop 124 that includes a cover and screen, and a bottom portion 128 that includes a keyboard. The first and second connectors 12 and 14 of the hinge 10 may be added to top portion and bottom portion 128 such that they can be disconnected when aligned. In an embodiment, the first connectors 12 may be provided on one portion (e.g., on the bottom portion 128), while the second connectors 14 are provided on the other portion (e.g., on the top portion 126). In another embodiment, a first connector 12 is provided on one side of a portion, while a second connector is provided on the other, opposite side of the same portion (e.g., the bottom portion has a first connector 12 on a left side, and a second connector 14 on its right side, to form the hinges 10). The positioning of parts and assembly of the hinge devices is not intended to be limiting, however. Accordingly, as shown in FIG. 31, when the top portion 126 and bottom portion 128 are relatively rotated such that the tabs and recesses are aligned, the first connectors and second connectors are configured for disconnection via movement away from each other, e.g., by moving the top portion 126 towards the left and the bottom portion 128 towards the right.

In addition, for purposes of this disclosure, in embodiments, the disclosed hinge assembly may be provided in electronic devices or products in addition to/other than those previously listed, including, but not limited to, personal computers, portable and desktop tablet or slate style computing devices, handheld electronic, and/or communication devices, e.g., smartphones, digital music players, multi-function devices, etc., and/or any storage device of digital media. In accordance with one embodiment, the hinge assembly 10 is provided in a non-consumer electronic product.

While the principles of the disclosure have been made clear in the illustrative embodiments set forth above, it will be apparent to those skilled in the art that various modifications may be made to the structure, arrangement, proportion, elements, materials, and components used in the practice of the disclosure.

It will thus be seen that the features of this disclosure have been fully and effectively accomplished. It will be realized, however, that the foregoing preferred specific embodiments have been shown and described for the purpose of illustrating the functional and structural principles of this disclosure and are subject to change without departure from such principles. Therefore, this disclosure includes all modifications encompassed within the spirit and scope of the following claims.

What is claimed is:

1. A removably interlocking barrel hinge assembly, comprising:
a first connector comprising a first body with a first opening therethrough, the first body having an inner wall surrounding the opening and a plurality of tabs spaced circumferentially around the inner wall, each of the tabs projecting from the inner wall into the opening;
a second connector comprising a second body with a second opening therethrough, the second body having an outer wall with a shoulder extending therefrom and a receiving slot, the receiving slot configured for receipt of and sliding movement in a sliding direction of the plurality of tabs of the first body therein and the shoulder configured to limit motion of the tabs in an axial direction;
the shoulder further including a corresponding number of recesses of complimentary shape to the plurality of tabs, the corresponding number of recesses being spaced circumferentially around the shoulder;
the first opening and the second opening of the connectors being axially aligned;
wherein at least one of the first connector and the second connector is configured for rotation about the axis relative to the other connector such that the tabs of the first connector are moved relatively in the sliding direction within the slot of the second connector and are secured at least part by the shoulder, thereby preventing separation of the first and second connectors in the axial direction;
wherein, upon alignment of the plurality of tabs of the first connector with the recesses in the shoulder of the second connector, the first connector and second connector are configured for disconnection in the axial direction via movement away from each other along the axis.

2. The removably interlocking barrel hinge assembly according to claim 1, wherein alignment of the plurality of tabs of the first connector with the recesses in the shoulder of the connector is at 0 degrees of relative rotation.

3. The removably interlocking barrel hinge assembly according to claim 1, wherein the first connector and the second connector are configured for relative rotation up to approximately 90 degrees.

4. The removably interlocking barrel hinge assembly according to claim 1, wherein the first connector and the second connector are configured for relative rotation up to approximately 180 degrees.

5. The removably interlocking barrel hinge assembly according to claim 1, wherein the first connector and the second connector are configured for relative rotation up to approximately 270 degrees.

6. The removably interlocking barrel hinge assembly according to claim 1, wherein the plurality of tabs of the first connector are not evenly spaced circumferentially around the inner wall.

7. The removably interlocking barrel hinge according to claim 1, wherein at least one tab of the plurality of tabs of the first connector has a different circumferential length as compared to other tabs.

8. The removably interlocking barrel hinge according to claim 1, wherein the first connector comprises no more than five tabs, and wherein at least two of the tabs have similar circumferential length and at least one other tab has a differential circumferential length.

9. A knife comprising:
a blade;
a blade protector device;
a removably interlocking barrel hinge assembly connecting the blade and the blade protector device, the removably interlocking barrel hinge assembly comprising:
a first connector provided on the blade having a first opening therethrough, the blade having an inner wall surrounding the opening and a plurality of tabs spaced circumferentially around the inner wall, each of the tabs projecting from the inner wall into the opening;
a second connector provided on the blade protector device having a second opening therethrough, the blade protector device having an outer wall with a shoulder extending therefrom and a receiving slot, the receiving slot configured for receipt of and sliding movement in a sliding direction of the plurality of tabs of the blade therein and the shoulder configured to limit motion of the tabs in an axial direction;
the shoulder further including a corresponding number of recesses of complimentary shape to the plurality of tabs, the corresponding number of recesses being spaced circumferentially around the shoulder;
the first opening and the second opening of the connectors being axially aligned;
wherein at least one of the first connector and the second connector is configured for rotation about the axis relative to the other connector such that the tabs of the first connector are moved relatively in the sliding direction within the slot of the second connector and are secured at least part by the shoulder, thereby preventing separation of the first and second connectors in the axial direction, and allowing relative rotation of the blade and blade protector device;
wherein, upon alignment of the plurality of tabs of the first connector with the recesses in the shoulder of the second connector, the first connector and second connector are configured for disconnection in the axial direction via movement away from each other along the axis, thereby disconnecting the blade from the blade protector device.

10. The knife according to claim 9, wherein the blade protector device is an elongated handle.
